(19) United States
(12) Patent Application Publication
(10) Pub. No.: US 2008/0166271 A1
(43) Pub. Date: Jul. 10, 2008

(54) LIQUID CONCENTRATION CONTROL SUPPLY APPARATUS

(76) Inventors: CHUN-CHIN TUNG, Chupei (TW); Tung-Lieh Chien, Chupei (TW)

Correspondence Address: G. LINK CO., LTD., 3550 BELL ROAD, MINOOKA, IL, 60447, US

(21) Appl. No.: 11/968,491

(22) Filed: Jan. 2, 2008

(30) Foreign Application Priority Data
Jan. 10, 2007 (TW) 096100888

(51) Int. Cl. G05D 9/00

(52) U.S. Cl. 422/106

(57) ABSTRACT

A liquid concentration control and supply apparatus used in a reaction apparatus is disclosed. A control element in the liquid concentration control and supply apparatus controls its operating steps, comprising detecting the mixed liquid concentration in a liquid mixing device, detecting the height of mixed liquid level in the liquid mixing device, determining whether the mixed liquid concentration falls within a lag range referencing to a preset concentration value, and based on the information on the mixed liquid concentration and the mixed liquid level, computing the anticipated height of mixed liquid level after the amount of liquid that needs to be output by the liquid storage device is added to the liquid mixing device and controlling the output of liquid from the liquid storage device so that the mixed liquid concentration falls within the lag range referencing to the preset concentration value.

### FIELD OF THE INVENTION

The present invention relates to a liquid concentration control and supply apparatus, more particularly a kind of liquid concentration control and supply apparatus that uses the feedback of liquid level detection and concentration detection information to control the liquid concentration desired.

### BACKGROUND OF THE INVENTION

In the prior art, the control of fuel concentration in a fuel cell mostly uses a simple concentration detector that conducts passive detection, which does not allow the replenishing of fuel in a timely manner to keep the fuel concentration at a certain level. In a fuel cell the fuel concentration drops after cell reacts with the fuel. If the fuel concentration is not effectively controlled afterwards, the reaction membrane in the fuel cell will not be able to provide adequate output energy. When not much energy supply is needed, high fuel concentration will damage the reaction membrane in the cell, thereby producing adverse effect on the fuel cell.

In light of the drawbacks of conventional fluid measuring devices, the inventor develops an improved capacitance-type level meter coupled with a liquid concentration detector that allows the fuel concentration in a fuel cell to stay constant. Such configuration can effectively control the fuel concentration in a fuel cell, thereby offering the advantage of controlling fuel concentration more accurately as compared with the prior art. The present invention not only accurately detects the concentration of fuel in the fuel cell, it can also work as an apparatus that replenishes the fuel when fuel concentration becomes insufficient.

### SUMMARY OF THE INVENTION

The primary object of the invention is to provide a liquid concentration control and supply apparatus which utilizes a liquid level information and concentration information feedback mechanism to control the concentration of liquid supplied to a reaction apparatus for chemical reaction within a specific range.

Another object of the invention is to provide a liquid concentration control and supply apparatus that can recover the reaction products from the reaction apparatus to regulate the concentration of liquid needed by the reaction apparatus.

Yet another object of the invention is to provide a liquid concentration control and supply apparatus used in a reaction apparatus, where the reaction apparatus can be a fuel cell system, for the control of fuel concentration and fuel supply.

A further object of the invention is to provide a liquid concentration control and supply apparatus that can recover the water in the reaction products of fuel cell and transport it to itself, thereby regulating the concentration of liquid fuel needed by the fuel cell.

To achieve the aforesaid objects, the present invention provides a liquid concentration control and supply apparatus used in a reaction apparatus and for controlling the concentration of liquid fed into the reaction apparatus for undergoing chemical reaction. The liquid concentration control and supply apparatus comprises a liquid mixing device, a liquid level sensor, a liquid transport device, a liquid concentration detector, a liquid storage device, and a control element. The control element controls the operating steps of the liquid concentration control and supply apparatus, comprising detecting the mixed liquid concentration in the liquid mixing device; detecting the height of mixed liquid level in the liquid mixing device; determining whether the mixed liquid concentration falls within a lag range referencing to the preset concentration value, and based on the information on the mixed liquid concentration and the mixed liquid level, computing the anticipated height of mixed liquid level after the amount of liquid that needs to be output by the liquid storage device is fed to the liquid mixing device and controlling the output of liquid from the liquid storage device so that the height of mixed liquid level in the liquid mixing device reaches the anticipated height of mixed liquid level; the control element stopping the output of replenishing liquid by the low-concentration storage tank in the liquid storage device; and when the mixed liquid concentration falls within the lag range referencing to the preset concentration value, detecting the liquid concentration with the liquid concentration detection sensor.

Moreover, the reaction apparatus can be a fuel cell device. Thus the liquid concentration control and supply apparatus of the invention can supply the fuel needed by the electrochemical reaction of the fuel cell device and recover the water produced after the fuel cell device has undergone electrochemical reaction.

The objects, features and effects of the invention are described in detail below with embodiments in reference to the accompanying drawings.

### DESCRIPTION OF THE DRAWINGS

FIG. 1 is a component diagram of the liquid concentration control and supply apparatus according to the invention;

FIG. 2 is a diagram illustrating an embodiment of the liquid concentration control and supply apparatus according to the invention;

FIG. 3 is a flow chart for the operating steps of the liquid concentration control and supply apparatus according to the invention;

FIG. 4 is a diagram illustrating another embodiment of the liquid concentration control and supply apparatus according to the invention; and

FIG. 5 is a flow chart for the operating steps of the liquid concentration control and supply apparatus shown in FIG. 4.

### DETAILED DESCRIPTION OF THE INVENTION

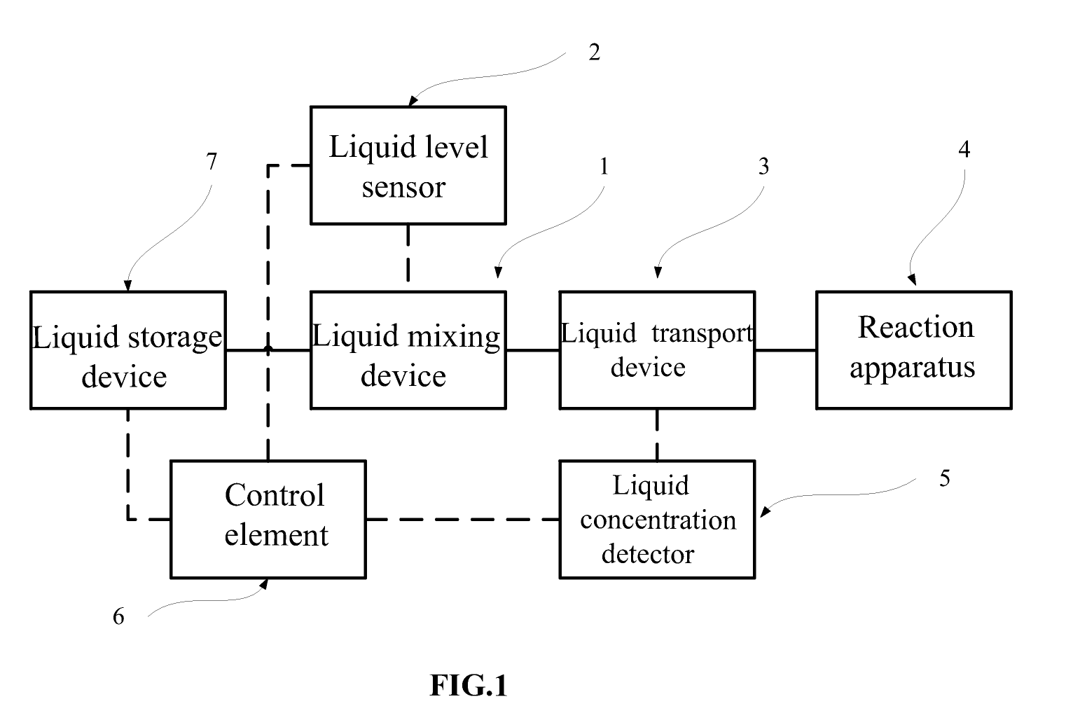

FIG. 1 is a component diagram of the liquid concentration control and supply apparatus according to the invention. The liquid concentration control and supply apparatus comprises a liquid mixing device (1), a liquid level sensor (2), a liquid transport device (3), a reaction apparatus (4), a liquid concentration detector (5), a control element (6), and a liquid storage device (7). The preferred embodiments of the invention are illustrated in detail below.

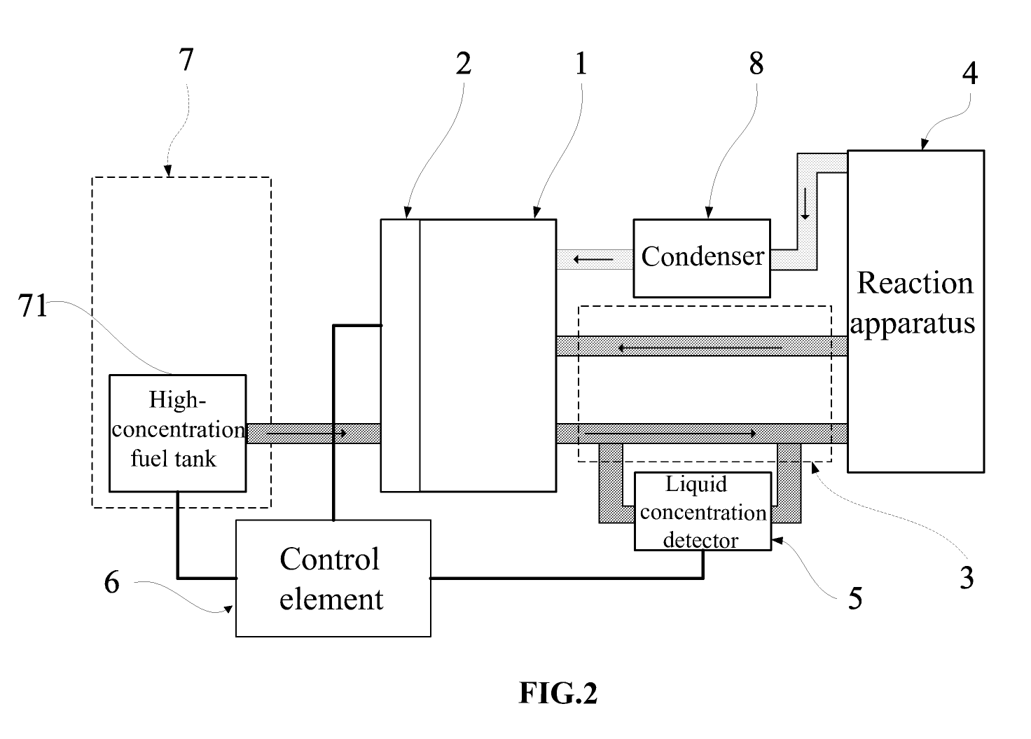

FIG. 2 is a diagram illustrating an embodiment of the liquid concentration control and supply apparatus implemented in a fuel cell device. The liquid mixing device (1) is a device that mixes and adjusts the fuel concentration of fuel cell and stores the concentration-adjusted fuel; the liquid transport device (3) is a fluid guide device that transports the fuel in liquid mixing device (1) to the reaction apparatus (4) where the residual fuel after reaction is transported back to the liquid mixing device (1) such that there is circulation and connection between the liquid mixing device (1) and the reaction apparatus (4) via the liquid transport device (3); the reaction apparatus (4) is a fuel cell having catalyst capable of reacting with the liquid fuel therein; the liquid concentration detector (5) detects the concentration of fuel in the liquid mixing device (1) and the liquid transport device (3), and defines it as mixed liquid concentration C1; the control element (6) controls the operation of the liquid concentration control and supply apparatus and the logic operation it requires; the liquid storage device (7) stores fuel with specific concentration and supplies fuel to the liquid mixing device (1). The concentration of liquid to be used by the reaction apparatus (4) must be put under control to optimize the reaction efficiency of the fuel cell and protect and prolong the service life of the cell. Thus the liquid transport device (3) is coupled with a liquid concentration detector (5) to detect the concentration of liquid that enters the reaction apparatus (4), which is defined as mixed liquid concentration C1, and the message is transmitted to the control element (6). If the liquid concentration as detected by the liquid concentration detector (5) is below a system-set preset concentration value C0, the control element (6) would take into account the liquid level height fed back by the liquid level sensor (2) and control the feeding of liquid in the liquid storage device (7) to the liquid mixing device (1). The concentration of replenishing liquid in the liquid storage device (7) is defined as replenishing liquid concentration C2, which is higher than the preset concentration value C0. When the mixed liquid concentration C1 in the reaction apparatus (4) reaches the system-preset concentration value C0, the control element (6) would stop the liquid storage device (7) from feeding the liquid to the liquid mixing device (1) as a means to control the liquid concentration.

The amount of mixed liquid stored in the liquid mixing device (1) is defined as a first liquid volume L1. The amount of liquid contained in the liquid transport device (3) and transported to the reaction apparatus (4) is defined as a second liquid volume L2. The amount of replenishing liquid in the liquid storage device (7) that is fed to the liquid mixing device (1) is defined as a third liquid volume L3.

The liquid concentration control and supply apparatus in this embodiment further comprises a condenser (8), the condenser (8) being a heat radiation device and a fluid guide device and mechanically connected to the reaction apparatus (4) and the liquid mixing device (1) such that the gaseous fluid produced after chemical reaction has taken place in the reaction apparatus (4) is guided into the condenser (8), in which, the gaseous fluid is condensed into liquid fluid and directly fed into the liquid mixing device (1), in which it is mixed with the liquid in the liquid mixing device (1). As a result, the mixed liquid concentration C1 will drop gradually until it is below the preset concentration value C0.

The liquid storage device (7) feeds the liquid therein to the liquid mixing device (1) through a pump or any fluid driving device.

The liquid level sensor (2) uses parallel plate capacitance-based level meter to detect the liquid volume in liquid mixing device (1). The key technology is disclosed in inventor's ROC Patent No. 94221746, according to which, the liquid mixing device (1) is externally installed with two parallel plate capacitors and calculates the liquid volume in the liquid mixing device (1) based on the capacitance measured by the parallel plate capacitors. The liquid volume calculated is integrated with the signal of liquid concentration detector (5) as read by the control element (6). The liquid concentration detector (5) uses optical element to detect the liquid concentration. The key technology is disclosed in inventor's ROC Patent No. 95133612, according to which, the liquid concentration is determined based on the receipt of light source by fuels with different concentrations. Based on the liquid concentration detected, the fuel in the liquid storage device (7) is acted on as a means to control the liquid concentration.

Another implementation of the liquid level sensor (2) uses single-side capacitance-based level meter to measure the liquid volume in the liquid mixing device (1). The key technology is disclosed in inventor's ROC Patent No. 95104177, which utilizes the characteristics of capacitance effect where capacitance varies under varying dielectric constants caused by the different proportions of liquid and air in the liquid mixing device (1), and based on which to measure the liquid volume therein.

The height of mixed liquid level in the liquid mixing device (1) as detected by the liquid level sensor (2) corresponds to the first liquid volume L1 of the mixed liquid in the liquid mixing device (1). When the mixed liquid concentration C1 is below the preset concentration value C0, and after the information on the height of mixed liquid level is transmitted to the control element (6), the control element (6) can, based on the mixed liquid level height information and the mixed liquid concentration C1, calculate the amount of replenishing liquid needed from the liquid storage device (7), i.e. the third liquid volume L3, and obtains the anticipated height of mixed liquid level in the liquid mixing device (1) after the addition of the first liquid volume L1. When the amount of replenishing liquid output by the liquid storage device (7) to the liquid mixing device (1) reaches the third liquid volume L3, or when the height of mixed liquid level in the liquid mixing device (1) after the feeding of replenishing liquid from the liquid storage device (7) reaches the anticipated height of mixed liquid level, the mixed liquid concentration C1 will fall in the lag range referencing to the preset concentration value C0. At the same time, the control element (6) stops the feeding of replenishing liquid from the liquid storage device (7) to the liquid mixing device (1).

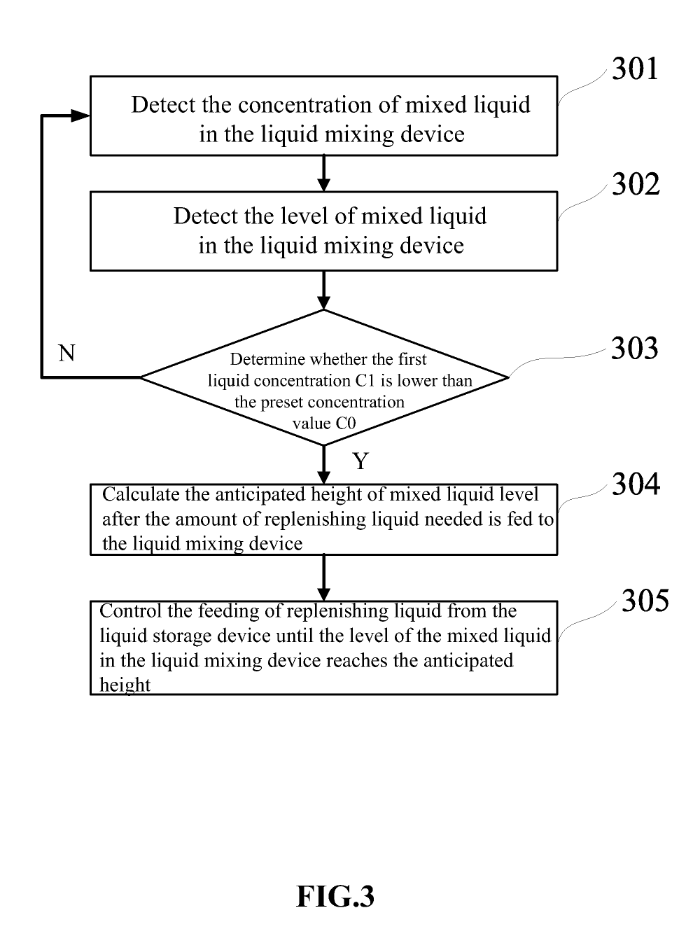

FIG. 3 is a flow chart for the operating steps of the liquid concentration control and supply apparatus according to the invention. The liquid concentration control and supply apparatus comprises the steps of: step 301—the liquid concentration detector (5) detects the concentration of liquid fed from the liquid mixing device (1) to the reaction apparatus (4) to obtain a mixed liquid concentration C1 in the liquid mixing device (1); step 302—the liquid level sensor (2) detects the height of mixed liquid level in the liquid mixing device (1) and transmits the information on the height of mixed liquid level to the control element (6); step 303—the control element (6) determines whether the mixed liquid concentration C1 detected falls in a lag range referencing to a preset concentration value C0; if yes, the control element (6) returns to step 301: if not, the control element (6) goes to step 304; step 304—the control element (6), based on the height of mixed liquid level as detected by the liquid level sensor (2), calculates an anticipated height of mixed liquid level after the replenishing liquid corresponding to the amount that should be supplied is added into the liquid mixing device (1); and step 305—the control element (6), working with the liquid level sensor (2), controls the output of replenishing liquid by the liquid storage device (7) until the amount of replenishing liquid output by the liquid storage device (7) reaches the third liquid volume L3, or until the height of mixed liquid level in the liquid mixing device (1) which is the sum of third liquid volume L3 and the first liquid volume L1 reaches the anticipated height of mixed liquid level. At this time, the mixed liquid concentration C1 would fall in the lag range referencing to the preset concentration value C0, and the control element (6) would stop the output of replenishing solution by the liquid storage device (7).

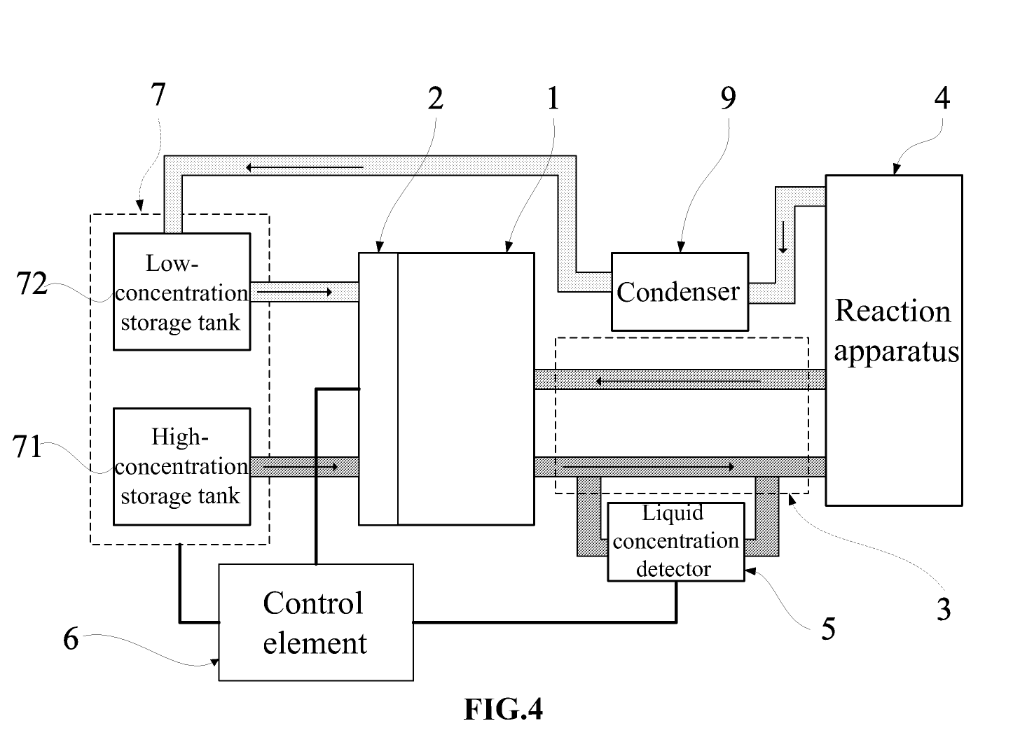

FIG. 4 is a component diagram illustrating another embodiment of the liquid concentration control and supply apparatus, which is also implemented in a fuel cell device. In this embodiment, the liquid concentration control and supply device further comprises a condenser (9), and the liquid storage device (7) further contains a high-concentration storage tank (71) and a low-concentration storage tank (72). The condenser (9) is a heat radiation device and a fluid guide device and mechanically connected to the reaction apparatus (4) and the low-concentration storage tank (72) such that the gaseous fluid produced after chemical reaction has taken place in the reaction apparatus (4) is guided into the condenser (9), in which, the gaseous fluid is condensed into liquid fluid and directly fed into the low-concentration storage tank (72). The high-concentration storage tank (71) of the liquid storage device (7) stores replenishing liquid with concentration C2. The low-concentration storage tank (72) is mechanically to the condenser (9) and stores the liquid from the condenser (9).

In this embodiment when the mixed liquid concentration C1 is out of the lag range referencing to preset concentration value C0, the control element (6), through the liquid concentration detector (5), controls the transport of liquid fuel in the high-concentration storage tank (71) or low-concentration storage tank (72) of the liquid storage device (7) to the liquid mixing device (1) until the mixed liquid concentration C1 falls in the lag range referencing to the preset concentration value C0. The liquid concentration in the low-concentration storage tank (72) is defined as diluting liquid concentration C3. The amount of liquid output by the low-concentration storage tank (72) is defined as the fourth liquid volume L4.

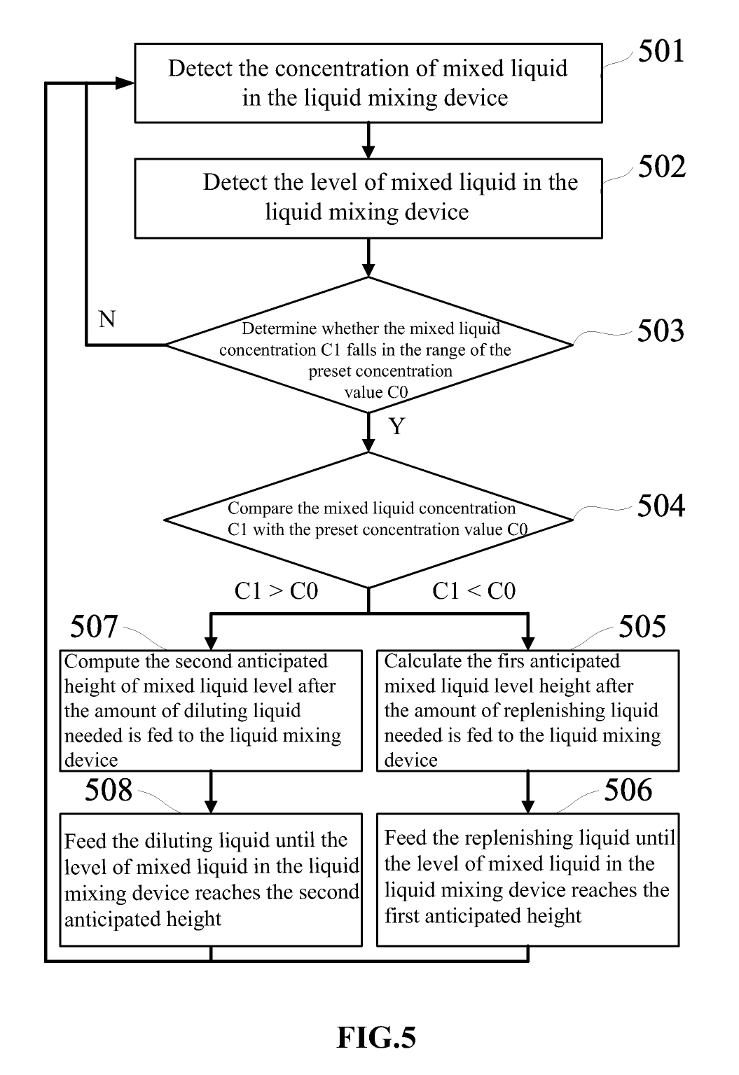

FIG. 5 is a flow chart for the operating steps of the liquid concentration control and supply apparatus according to the embodiment in FIG. 4. The liquid concentration control and supply apparatus comprises the steps of: step 501—the liquid concentration detector (5) detects the concentration of liquid fed from the liquid mixing device (1) to the reaction apparatus (4) to obtain a mixed liquid concentration C1 in the liquid mixing device (1); step 502—the liquid level sensor (2) detects the height of mixed liquid level in the liquid mixing device (1) and transmits the information on the height of mixed liquid level to the control element (6); step 503—the control element (6) determines whether the mixed liquid concentration C1 detected falls in a lag range referencing to a preset concentration value C0; if yes, the control element (6) returns to step 501; if not, the control element (6) goes to step 504; step 504—the mixed liquid concentration C1 is compared to preset concentration value C0; if C1<C0, go to step 505; if C1>C0, go to step 507; step 505—the control element (6), based on the height of mixed liquid level as detected by the liquid level sensor (2), calculates a first anticipated height of mixed liquid level after replenishing liquid corresponding to the amount that should be supplied is added into the liquid mixing device (1); step 506—the control element (6), working with the liquid level sensor (2), controls the output of replenishing liquid by the high-concentration storage tank (71) of liquid storage device (7) until the amount of replenishing liquid output by the high-concentration storage tank (71) reaches the third liquid volume L3, or until the height of mixed liquid level in the liquid mixing device (1) which is the sum of the third liquid volume L3 and the first liquid volume L1 reaches the first anticipated height of mixed liquid level: at this time, the mixed liquid concentration C1 would fall in the lag range referencing to the preset concentration value C0, and the control element (6) would stop the output of replenishing solution from the high-concentration storage tank (71) of the liquid storage device (7) and return to step 501; step 507—the control element (6), based on the height of mixed liquid level as detected by the liquid level sensor (2), calculates a second anticipated height of mixed liquid level after a fourth liquid volume L4 that needs to be output by the low-concentration storage tank (72) of the liquid storage device (7) is added into the liquid mixing device (1); step 508—the control element (6), working with the liquid level sensor (2), controls the output of diluting liquid by the low-concentration storage tank (72) of liquid storage device (7) until the amount of replenishing liquid output by the liquid storage device (7) reaches the fourth liquid volume L4, or until the height of mixed liquid level in the liquid mixing device (1) which is the sum of the fourth liquid volume L4 and the first liquid volume L1 reaches the second anticipated height of mixed liquid level; at this time, the mixed liquid concentration C1 would fall in the lag range referencing to the preset concentration value C0, and the control element (6) would stop the output of diluting solution from the low-concentration storage tank (72) of the liquid storage device (7) and return to step 501.

The liquid concentration detector (5) can be replaced by a current/voltage sensing means. The control element (6) can include a means to convert current/voltage to fuel concentration. The current/voltage sensing means detects the current/voltage value output by the fuel cell and transmits the information to the control element (6). The manes to convert current/voltage to fuel concentration converts the current/voltage of fuel cell into liquid concentration.

The solutes that define the replenishing liquid concentration C2 in high-concentration storage tank (71) and diluting liquid concentration C3 in low-concentration storage tank (72) are identical to the solutes that define the mixed liquid concentration C1.

In the embodiments of methods for controlling liquid concentration in the liquid concentration control and supply apparatus of the invention, the liquid transport device (3) can continue to operate and supply liquid to the reaction apparatus (4) in the process of liquid concentration control where the control element (6) controls the feeding of liquid from the liquid storage device (7) to the liquid mixing device (1).

As such, the liquid concentration control and supply apparatus of the invention utilizes capacitance-based liquid sensor coupled with concentration detector to control the liquid concentration desired. The invention possesses inventive step and meets the essential criteria for patent.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A liquid concentration control and supply apparatus used in a reaction apparatus for controlling the concentration of liquid input into the reaction apparatus to undergo chemical reaction, the liquid concentration control and supply apparatus comprising:
a liquid mixing device, being a mixed liquid storage vessel;
a liquid level sensor arranged in the liquid mixing device for detecting the height of mixed liquid level in the liquid mixing device;
a liquid transport device, being mechanically connected to the liquid mixing device and the reaction apparatus for transporting the liquid in the liquid mixing device to the reaction apparatus and transporting the liquid in the reaction apparatus after reaction to the liquid mixing device;
a liquid concentration detector for detecting the concentration of liquid be transported from the liquid mixing device to the reaction apparatus and defining said concentration as a mixed liquid concentration;
a liquid storage device comprising a high-concentration storage tank for storing the replenishing liquid, the concentration of the replenishing liquid being higher than a preset concentration, the liquid mixing device transporting the liquid stored therein to the liquid mixing device; and
a control element for controlling the operation of the liquid concentration control and supply apparatus, comprising the steps of:
the liquid concentration detector detecting the mixed liquid from the liquid mixing device to the reaction apparatus to obtain the mixed liquid concentration;
the liquid level sensor detecting the height of mixed liquid level in the liquid mixing device and transporting the same information to the control element;
the control element determining whether the mixed liquid concentration detected falls in a lag range referencing to the preset concentration;
when the mixed liquid concentration is below the lag range referencing to the preset concentration, the control element, based on the information on the height of mixed liquid level fed back by the liquid level sensor, computing a first anticipated height of mixed liquid level after replenishing liquid output by the high-concentration storage tank is added into the liquid mixing device;
the control element controlling the output of replenishing liquid by the high-concentration storage tank of the liquid storage device until the height of mixed liquid level in the liquid mixing device reaches the first anticipated height of mixed liquid level, and upon which, the control element stopping the output of replenishing liquid by the high-concentration storage tank of the liquid storage device; and
when the mixed liquid concentration falls in the lag range referencing to the preset concentration, carrying out the step of concentration detection by the liquid concentration detector.

2. The liquid concentration control and supply apparatus according to claim 1, further comprising a condenser, the condenser being a heat radiation device and fluid guide device, and mechanically connected to the reaction apparatus and the liquid mixing device, the gaseous fluid produced by the reaction apparatus after chemical reaction being fed into the condenser, the condenser condensing the gaseous fluid entered into liquid fluid and guiding it directly into the liquid mixing device.

3. The liquid concentration control and supply apparatus according to claim 1, the liquid storage device further comprising a low-concentration storage tank, the low-concentration storage tank storing diluting liquid, the concentration of the diluting liquid being lower than the preset concentration.

4. The liquid concentration control and supply apparatus according to claim 3, wherein the control element controlling the operation of the liquid concentration control and supply apparatus further comprises the steps of:
when the mixed liquid concentration is higher than the lag range referencing to the preset concentration, the control element, based on the height of mixed liquid level as detected by the liquid level sensor, computing a second anticipated height of mixed liquid level after diluting liquid output by the low-concentration storage tank is added into the liquid mixing device; and
the control element controlling the output of diluting liquid by the low-concentration storage tank of liquid storage device until the height of mixed liquid level in the liquid mixing device reaching the second anticipated height of mixed liquid level, and upon which, the control element stopping the output of diluting liquid by the low-concentration storage tank of the liquid storage device.

5. The liquid concentration control and supply apparatus according to claim 1, further comprising a condenser, and the liquid storage device further comprising a low-concentration storage tank, the condenser being a heat radiation device and fluid guide device, and mechanically connected to the reaction apparatus and the low-concentration storage tank, the gaseous fluid produced by the reaction apparatus after chemical reaction being fed into the condenser, the condenser condensing the gaseous fluid entered into liquid fluid and guiding it directly into the low-concentration storage tank.

6. The liquid concentration control and supply apparatus according to claim 5, wherein the control element controlling the operation of the liquid concentration control and supply apparatus further comprises the steps of:
when the mixed liquid concentration is higher than the lag range referencing to the preset concentration, the control element, based on the height of mixed liquid level as detected by the liquid level sensor, computing a second anticipated height of mixed liquid level after diluting liquid output by the low-concentration storage tank is added into the liquid mixing device; and
the control element controlling the output of diluting liquid by the low-concentration storage tank of liquid storage device until the height of mixed liquid level in the liquid mixing device reaching the second anticipated height of mixed liquid level, and upon which, the control element stopping the output of diluting liquid by the low-concentration storage tank of the liquid storage device.

7. The liquid concentration control and supply apparatus according to claim 1, wherein the reaction apparatus is a fuel cell device.

8. The liquid concentration control and supply apparatus according to claim 1, wherein the liquid level detector is a planar stripline capacitor.

9. The liquid concentration control and supply apparatus according to claim 1, wherein the liquid concentration detector is a specific heat-based sensor.

10. The liquid concentration control and supply apparatus according to claim 1, wherein the reaction apparatus is a fuel cell, and the liquid concentration detector is a optical sensor for measuring the liquid concentration.

11. The liquid concentration control and supply apparatus according to claim 1, wherein the liquid concentration detector includes a current/voltage sensing means, and the control element includes a means to convert current/voltage into fuel concentration, the current/voltage sensing means being for detecting the current/voltage value output by the fuel cell and transmitting the signal on current/voltage value to the control element, the means to convert current/voltage into fuel concentration being for converting the current/voltage of the fuel cell into liquid concentration.

12. The liquid concentration control and supply apparatus according to claim 1, wherein the solutes for defining the replenishing liquid concentration in high-concentration storage tank and diluting liquid concentration in low-concentration storage tank are identical to the solutes defining the mixed liquid concentration.
